(19) United States
(12) Patent Application Publication
(10) Pub. No.: US 2025/0128239 A1
(43) Pub. Date: Apr. 24, 2025

(54) SYSTEMS AND METHODS FOR REGENERATING A SORBENT

(71) Applicant: Saudi Arabian Oil Company, Dhahran (SA)

(72) Inventors: Mourad Younes, Dhahran (SA); Abdullah Al Rammah, Dhahran (SA); Aqil Jamal, Dhahran (SA)

(21) Appl. No.: 18/490,192

(22) Filed: Oct. 19, 2023

(51) Int. Cl. B01J 20/34; B01D 53/02; B01J 20/22; C10L 3/10

(52) U.S. Cl. CPC B01J 20/3483; B01D 53/02; B01J 20/226; B01J 20/3425; B01J 20/3491; C10L 3/104; B01D 2253/204; B01D 2257/504; B01D 2259/40098

(57) ABSTRACT

A method of treating a sorbent having a species sorbed thereto includes reacting a first reactant and a second reactant to generate heat, and heating the sorbent with the generated heat to desorb the sorbed species form the sorbent. The first reactant includes a molecule having the same chemical identity as the sorbed species. Systems for carrying out such methods are provided.

### FIELD

The disclosure generally relates to systems and methods for regenerating a sorbent used in an adsorption or an absorption process. The methods can include utilizing heat generated from a chemical reaction to regenerate the sorbent.

### BACKGROUND

It can be desirable to capture CO₂ to reduce the possibility that the CO₂ concentration increases in the environment and has a negative impact on the environment. It is common to achieve this by adsorbing the CO₂ to a sorbent. This approach can be used, for example, when the CO₂ is initially present in a mixture of gases, such as in ambient air or CO₂ generated and emitted from a point source, e.g., a power plant.

### SUMMARY

The disclosure generally relates to systems and methods for regenerating a sorbent. As an example, the methods can include at least partially regenerating a sorbent by the heat generated from an exothermic chemical reaction.

The systems and methods disclosed herein can have applications in processes such as thermal swing adsorption where energy is provided to the sorbent to allow for desorption of the sorbed (captured) species and regeneration of the sorbent.

The disclosed systems and methods can provide one or more of a variety of benefits. As an example, the regeneration process can utilize heat (e.g., waste heat) that is produced from energy or chemical processes that would otherwise be lost or inefficiently recovered. The systems and methods can allow for synergy with processes that convert sorbed species into valuable products. For example, the integration of the capture process with an exothermic reaction can reduce the cooling load needed to cool the exothermic reaction and reduce the heating load needed to regenerate the sorbent to desorb the sorbed species. The systems and methods can allow for the sequential capture and conversion of the sorbed species, which can reduce the transport cost of species sorbed by the sorbent.

In an aspect, the disclosure provides a method of treating a sorbent having a species sorbed thereto. The method includes reacting a first reactant and a second reactant to generate heat, and heating the sorbent with the generated heat to desorb the sorbed species from the sorbent. The first reactant includes a molecule having the same chemical identity as the sorbed species.

In some embodiments, the first and second reactants include gases.

In some embodiments, the sorbed species and the first reactant include CO₂.

In some embodiments, the method further includes using the desorbed CO₂ as a feedstock for urea production.

In some embodiments, the second reactant includes at least one member selected from the group consisting of ammonia, an epoxide, a phenolate, and hydrogen.

In some embodiments, the second reactant includes ammonia.

In some embodiments, the sorbed species and the first reactant include CO₂, the second reactant includes ammonia, and the reacting forms ammonium carbamate.

In some embodiments, one of the following holds: the sorbent includes at least one member selected from the group consisting of an amine solvent, an ionic liquid, a hydroxide-containing liquid, and a caustic solution; and the sorbent includes at least one member selected from the group consisting of a metal organic framework (MOF), a covalent organic framework (COF), a zeolitic imidazolate framework (ZIF), a zeolite, a hyper cross-linked organic polymer (HCP), a Scholl-coupled organic polymer (SCP), a conjugated microporous organic polymer (CMP), an amine fixed on a solid support, and an amino polymer.

In some embodiments, the method further includes reducing a pressure adjacent the sorbent to desorb at least some of the sorbed species.

In some embodiments, an energy to desorb the sorbed species from the sorbent is equal to or lesser than an energy provided by the generated heat. In some embodiments, an energy to desorb the sorbed species from the sorbent is greater than an energy provided by the generated heat, and the method further includes providing additional heat to the sorbent.

In some embodiments, a molar flow ratio of the second reactant to the first reactant is between 2 and 6. In some embodiments, the reacting is carried out at a temperature between about 130° C. and about 230° C. In some embodiments, the exothermic reaction is carried out at a pressure between about 30 bar and about 300 bar.

In some embodiments, the sorbent is heated to a regeneration temperature of about 80° C. to about 200° C. In some embodiments, the method further includes preheating the sorbent to a temperature of about 50° C. to about 200° C.

In some embodiments, the method further includes transferring the heat to the sorbent using at least one member selected from the group consisting of a heat exchanger and a heating medium.

In some embodiments, the first reactant is a species desorbed from the sorbent.

In a further aspect, the disclosure provides a system configured to desorb a species from a sorbent. The system includes a reactor unit including the sorbent, a first inlet, a second inlet, a first outlet, and a circulation cycle. The system is configured so that, during use of the system the species is desorbed from the sorbent to provide a first gaseous reactant, a second gaseous reactant enters the system via the first inlet, a gas including the first and second gaseous reactants exits the reactor unit via the first outlet and passes through the circulation cycle where the gas is purified and compressed gas, the purified and compressed gas enters the system via the second inlet, and the first and second gaseous reactants in the purified and compressed stream react to provide heat that assists in the desorption of the species from the sorbent.

In a further aspect, the disclosure provides a system configured to desorb a species from a sorbent. The system includes a reactor unit including the sorbent, a first inlet, a second inlet, a first outlet, a second outlet, and a circulation cycle. The system is configured so that, during use of the system the species is desorbed from the sorbent to provide a first gaseous reactant, a first gas including the first gaseous reactant exits the reactor unit via the first outlet, and passes through the circulation cycle to purify the first gas, the purified first gas enters the reactor unit via the first inlet, a second gaseous reactant enters the system via the second inlet, the first and second gaseous reactants react within the reactor unit to provide heat that assists in the desorption of the adsorbed species from the sorbent and to provide a reaction product, and the first gas and the reaction product exit the reactor unit via the second outlet.

### BRIEF DESCRIPTION OF THE FIGURES

FIGS. 1A-1E schematically depicts a process for capturing CO₂ using a sorbent.

FIGS. 2A-2C schematically depict systems for a method.

### DETAILED DESCRIPTION

Provided herein are systems and methods for regenerating a sorbent. In general, the systems and methods include using the heat generated by reacting a first reactant and a second reactant to desorb a species (e.g., having the same chemical identity as the first species) from a sorbent. As an example, the systems and methods involve reacting gaseous CO₂ with a reactant, and using the heat generated by this reaction to desorb CO₂ from a sorbent, thereby regenerating the sorbent.

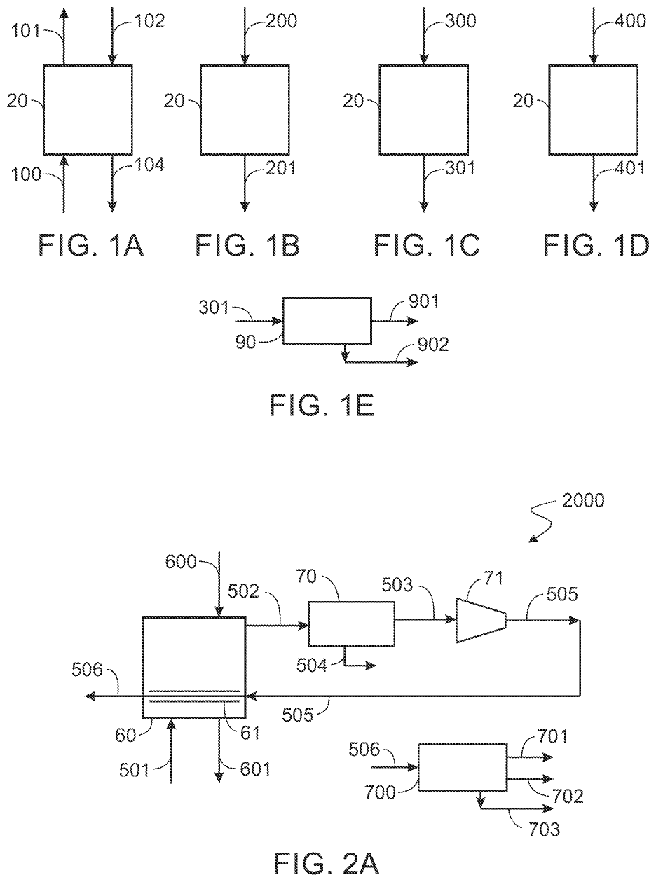

FIGS. 1A-1E schematically depict steps in a method according to the disclosure. While the methods in the disclosure apply to a variety of sorbents and sorbed species (see discussion below), FIGS. 1A-1E depict example processes that use solid sorbents (adsorbents) for CO₂ capture.

FIGS. 1A-1E schematically depict a process of capturing CO₂ using an adsorbent. The sorbent generally cycles through four phases, depicted in FIGS. 1A-1D. The first step is the adsorption phase in which adsorbates selectively adsorb to the sorbent (FIG. 1A). The second step is the purge phase in which the sorbent bed is purged of inert gases to improve product purity (FIG. 1B). The third step is the regeneration step in which the sorbent is heated to a regeneration temperature to desorb the adsorbates (FIG. 1C). The fourth step is a cooling step where the sorbent is brought back to the adsorption phase conditions (FIG. 1D).

FIG. 1A schematically depicts the first step in the CO₂ capture process, which is adsorption of CO₂ to the sorbent. In particular, FIG. 1A shows that a CO₂-containing stream 100 contacts a CO₂ capture unit 20 including a sorbent bed under conditions such that at least some of the CO₂ in the stream 100 adsorbs to the sorbent, resulting in stream 101 having a lower concentration of CO₂ than is present in the stream 100 (i.e., the stream 101 is a CO₂ deficient stream). In some embodiments, the CO₂-containing stream 100 is a stream resulting from an industrial process such as an industrial process involving one or more gas turbines, furnaces, cement plants, refineries, and/or steel making processes. In some embodiments, the CO₂ deficient stream 101 includes 0-5%, 5-20%, 20-50%, 50-70% or 70-99% of the CO₂ contained in the CO₂-containing stream 100. In some embodiments, the unit 20 is a circulating or fluidized bed designed to have, in addition to streams 100 and 101, a solid sorbent feed line for a CO₂ deficient stream 102 which flows co-currently, cross-flow, or counter currently to the gas streams 100, 101. This provides direct contact between the CO₂ in the gas stream 102 and the sorbent in the unit 20, allowing for the CO₂ deficient stream 102 to remove CO₂ from the sorbent, resulting in a CO₂ rich solid sorbent stream 104. In some embodiments, the sorbent stream 104 has a CO₂ loading of 5-10%, 10-20%, 20-30%, 30-40%, 40-50%, 50-60%, 60-70%, 70-80%, 80-90%, 90-95%, 95-99%, or 100% of the maximum sorbent CO₂ loading capacity.

FIG. 1B schematically depicts the second step in the CO₂ capture process, which is removal of inert gases from the sorbent bed, which occurs after the step shown in FIG. 1A. In particular, FIG. 1B depicts a purge gas 200 (e.g., steam) entering the CO₂ capture unit 20 containing the sorbent bed, which exits as stream 201 having a higher concentration of inert gases than purge gas 200. Alternatively or additionally, in some embodiments, the sorbent is purged of inert gases by reducing the pressure of the CO₂ capture unit 20. In some embodiments, in addition to removing inert gas from the sorbent, a partial amount of CO₂ desorbs during the purge process shown in FIG. 1B.

FIG. 1C schematically depicts the third step in the CO₂ capture process, which is regeneration of the sorbent, which occurs after the step shown in FIG. 1B. In particular, FIG. 1C depicts a CO₂ capture unit 20 being regenerated by providing a regeneration stream 300. Regeneration stream 300 provides heat to the sorbent. In a conventional CO₂ capture process, regeneration stream 300 can include steam or ammonia.

In the methods provided herein, the heat provided by regeneration stream 300 is formed directly or indirectly from a chemical reaction. In some embodiments, the regeneration stream 300 heats the sorbent and helps control the partial pressure of CO₂ in the bed to enable desorption of CO₂ from the sorbent. The exiting stream 301 has a higher concentration of CO₂ than the regeneration stream 300.

In some embodiments, the heat is generated from the reaction of CO₂ and ammonia. The reaction of CO₂ and ammonia forms ammonium carbamate (NH₂COONH₄), which is an intermediate in the production of urea (NH₂CONH₂), as shown in the following reaction schemes:

CO₂(g)+2NH₃(g)↔NH₂COONH₄(L) ΔH°=−117 to −160MJ/kmol (1)

NH₂COONH₄(L)↔NH₂CONH₂(L)+H₂O(L) ΔH°=15 to 33MJ/kmol (2)

The exothermic reaction of carbon dioxide with ammonia (1) releases a larger amount of energy than is involved in the endothermic decomposition reaction of ammonium carbamate into urea and water (2). Thus, the overall reaction to form urea from carbon dioxide and ammonia is exothermic, releasing approximately 101 to 128 MJ/kmol of ammonium carbamate (equivalent to 101 to 128 MJ/kmol CO₂, assuming 100% conversion to urea). CO₂ and ammonia can react relatively quickly and almost to completion to form the ammonium carbamate, which is accompanied by a heat release that can be used in the CO₂ capture process to heat the sorbent.

In some embodiments, a molar flow ratio of ammonia to CO₂ is between 2 and 6. In some embodiments, a molar flow ratio of ammonia to CO₂ is between 2 and 4, between 2 and 3, or between 2.5 and 3.

In some embodiments, the reaction of CO₂ and ammonia is carried out at a temperature between about 130° C. and about 230° C. In some embodiments, the reaction of CO₂ and ammonia is carried out at a temperature between about 170° C. and about 200° C.

In some embodiments, the reaction of CO₂ and ammonia is carried out at a pressure between about 30 bar and about 300 bar. In some embodiments, the reaction of CO₂ and ammonia is carried out at a pressure between about 100 bar and about 300 bar. In some embodiments, the reaction of CO₂ and ammonia is carried out at a pressure between about 110 bar and about 150 bar. In some embodiments, the heat generated from the reaction of CO₂ and ammonia is transferred to the sorbent using an appropriate heat transfer mechanism, such as a heat exchanger and/or a heating medium. In some embodiments, the sorbent is located adjacent or embedded within a reactor wherein the CO₂ reacts with ammonia (see discussion below). In some embodiments, the CO₂ and ammonia are reacted inside the unit 20 (see discussion below). In some embodiments, the unit 20 is located within a reaction chamber where the CO₂ and ammonia are reacted (see discussion below). In some embodiments, the sorbent is heated to a regeneration temperature of about 80° C. to about 200° C.

Sometimes the reaction of CO₂ and ammonia produces enough energy by itself to desorb CO₂ from the sorbent. In other words, the energy to desorb the CO₂ from the sorbent is equal to or lesser than an energy provided by the heat generated by the reaction of CO₂ and ammonia.

Sometimes the reaction of CO₂ and ammonia does not produce enough energy by itself to desorb CO₂ from the sorbent. In other words, the energy to desorb the CO₂ from the sorbent is greater than an energy provided by the heat generated by the reaction of CO₂ and ammonia. In some embodiments, additional energy (e.g., heat) is provided to the sorbent to help desorb the CO₂. In some embodiments, the additional heat is supplied by electric energy, electromagnetic systems, integrated heating coils, surrounding heating jackets, steam, or the like.

Optionally, regardless of whether the reaction of CO₂ and ammonia provides enough energy on its own to desorb CO₂, it may be desirable to further include one or more additional mechanisms to assist in regeneration, such as introducing vacuum or preheating the sorbent. In some embodiments, the method includes reducing the pressure adjacent the sorbent (e.g., introducing vacuum during regeneration) to desorb at least some of the CO₂. In some embodiments, the sorbent is preheated. In some embodiments, the method includes preheating the sorbent to a temperature of about 50° C. to about 200° C.

As noted above, FIG. 1D depicts the fourth step in the CO₂ capture process, which is a cooling step wherein the sorbent is brought back to the adsorption phase conditions after the process depicted in FIG. 1C. FIG. 1D schematically depicts that the cooling of CO₂ capture unit 20 by a cooling stream 400. In some embodiments, cooling stream 400 is air. In some embodiments, cooling stream 400 is an inert gas such as nitrogen or an intermediate process stream. The cooling stream 400 exits the sorbent bed as stream 401. In some embodiments, CO₂ capture unit 20 is cooled indirectly by an integrated cooling coil or a cooling jacket positioned around the sorbent bed. The CO₂ capture process shown in FIGS. 1A-1D can then be repeated.

The four steps of the CO₂ capture process depicted in FIGS. 1A-1D can be performed in sequential order, or can be performed in other orders. The regeneration step depicted in FIG. 1C can be performed independently, or it can be performed with one, two, or three of the steps depicted in FIGS. 1A, 1B, and 1D.

In some embodiments, an additional step includes purifying the CO₂ that is desorbed during the regeneration process (depicted in FIG. 1C). FIG. 1E schematically depicts a CO₂ recovery system 90 which compresses and purifies CO₂ stream 301 exiting the regeneration phase (see FIG. 1C) into a CO₂ stream 901 and separates water and/or other condensable species into stream 902.

The method can further include using the desorbed CO₂ in stream 901 as a feedstock to produce valuable products. In some embodiments, the method includes using the desorbed CO₂ in stream 901 as a feedstock for urea production. For example, the sorbent regeneration process can be integrated with a urea production process to use the heat generated during the formation of ammonium carbamate to regenerate the sorbent, and use the CO₂ desorbed from the sorbent as a feed for the urea production. The urea production process typically involves continuous cooling (e.g., with a cooling loop) to control the temperature of the reactor and prevent overheating. In some embodiments, the urea reactor can be cooled by dissipating the CO₂ and ammonia reaction energy to regenerate the sorbent. In some embodiments, this integration can allow for other synergistic benefits including saving on CO₂ capture and transport costs.

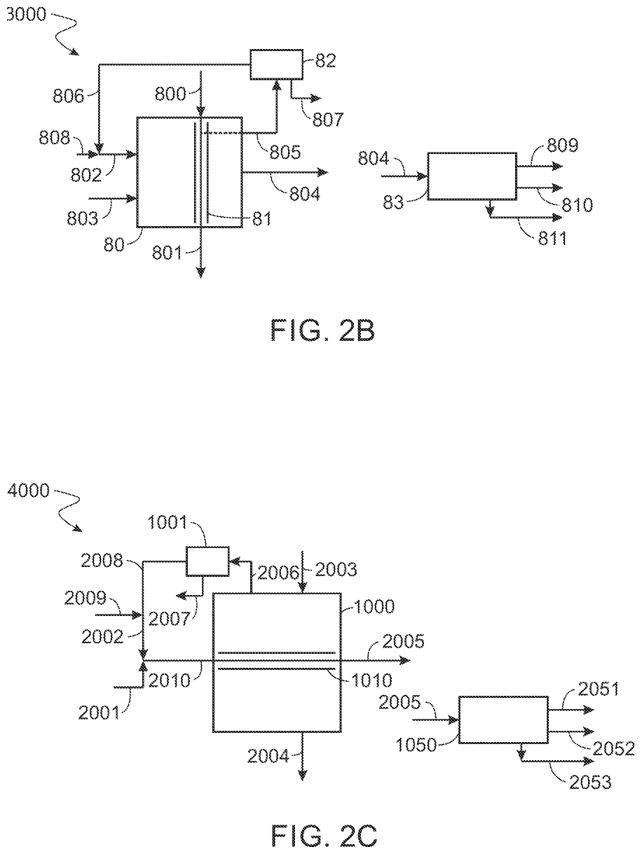

The CO₂ capture process and the urea production process can be integrated in several different ways depending on the characteristics of the sorbent and the CO₂ process. FIGS. 2A-2C depict systems for integration of sorbent regeneration and urea production.

FIG. 2A depicts an example system 2000 for the integration of the CO₂ capture process and the urea production process. The system 2000 has a CO₂ and ammonia reaction chamber 61 embedded within a reactor unit 60 including a CO₂ sorbent.

The reactor unit 60 can have any desired configuration, such as, for example, a fixed bed or a non-fixed bed configuration. In some embodiments, the reactor unit 60 has a fixed bed configuration where the sorbent is embedded in unit 60 and does not move. In some embodiments, the reactor unit 60 has a circulating or a fluidized bed configuration.

A CO₂ saturated sorbent stream 600 is provided to unit 60 and is heated inside unit 60 by the heat generated from the reaction chamber 61. The heat desorbs CO₂ from the sorbent to regenerate the sorbent, which leaves unit 60 as a CO₂ deficient sorbent stream 601.

An ammonia gas stream 501 can optionally be used to assist with desorbing CO₂. In some embodiments, the introduction of ammonia gas to the unit 60 via stream 501 reduces the partial pressure of CO₂ in unit 60, which assists desorbing CO₂ from the sorbent. In some embodiments, the ammonia stream 501 is introduced to the sorbent-containing bed at an elevated temperature to provide additional heat to the sorbent and assist regeneration. In some embodiments, the ammonia stream 501 enters at a temperature between about 60° C. and about 240° C., or between about 100° C. and about 200° C. In some embodiments, the ammonia enters at a pressure between 0.05 and 2 bar, or between 0.1 and 1 bar.

The ammonia and the desorbed species formed from the interaction of the ammonia stream 501 and the sorbent exit the unit 60 via a stream 502. In some embodiments, along with desorbed CO₂, the stream 502 can contain water that has desorbed from the sorbent. It may be desirable to remove the water from stream 502 because the presence of water can shift the equilibrium of the CO₂ and ammonia reaction towards the reactants, thereby reducing the yield of the overall reaction. It may also be desirable to remove the water from stream 502 because the presence of water with the CO₂ and ammonia feed can enable the formation of carbonate byproducts. In some embodiments, when water is captured and released by the sorbent alongside CO₂, a water removal unit downstream from the unit 60 removes the additional water.

A water removal unit 70 can remove water from the stream 502 to form a water stream 504 and a stream 503 that contains CO₂ and ammonia. In some embodiments, the unit 70 captures 1 to 100% of the water in stream 502, for example, 80 to 99% of the water in the stream 502. In some embodiments, additional CO₂ and ammonia is added to the stream 503 as desired to adjust the mass and energy balances of the integrated processes (such that enough CO₂ and ammonia react to supply sufficient energy to regenerate the sorbent) such that the NH₃ to CO₂ molar flow ratio has a desired value, such as between 2 and 4, or between 2.5 and 3. The additional CO₂ can be sourced, for example, from conventional carbon capture units.

The CO₂ and ammonia stream 503 is then compressed in a compression unit 71 to provide a CO₂ and ammonia stream having the urea reaction pressure. In some embodiments, the compression unit 71 includes compression and cooling stages to bring the stream 503 to the urea reactor pressure.

The stream 505 enters the reaction chamber 61 where CO₂ and ammonia react to form ammonium carbamate (see reaction mechanism above). The reaction chamber 61 is embedded or thermally linked to the unit 60 where the CO₂ rich sorbent is regenerated, such that the heat released by the ammonium carbamate reaction is transferred to the sorbent to release the adsorbates from the sorbent, thereby regenerating the sorbent. In some embodiments, the transfer of the heat to the solid sorbent lowers or controls the ammonium carbamate reactor temperature. In some embodiments, the reaction chamber 61 includes one or more tubes in direct contact with the solid sorbent for heat transfer.

In some embodiments, the sorbent stream 600 is preheated before entering unit 60 using external heaters. In some embodiments, the external heaters are used to supplement the energy provided by the ammonium carbamate reaction. For example, when the energy provided by the ammonium carbamate reaction is less than the energy to desorb the CO₂ from the sorbent.

An effluent stream 506 leaves the reactor 601. The effluent stream 506 contains species present due to the interaction of the stream 505 with the sorbent, such as ammonia carbamate, unreacted NH₃, H₂O and urea. In some embodiments, the CO₂ in the reaction chamber 61 is completely consumed. In some embodiments, a partial amount of CO₂ does not react and exits in the effluent stream 506.

In some embodiments, at least some of the species present in the effluent stream 506 can be separated from each other. For example, species in the effluent stream 506 can be separated by a unit 700 into a stream 701 that includes unreacted ammonia, a stream 702 that includes ammonium carbamate, and a stream 703 that includes a urea and water mixture. In general, the unit 700 can have any appropriate design. Units appropriate for separating of urea-containing effluents are disclosed, for example, U.S. Pat. Nos. 6,150,555 and 3,232,982.

In some embodiments, only the first reaction between CO₂ and NH₃ to form ammonium carbamate takes place in the reaction chamber 61 and the effluent stream 506, including ammonium carbamate, enters a second reactor in which ammonia carbamate decomposes into urea and water. In some embodiments, the reaction chamber 61 includes a section where the ammonium carbamate is decomposed into urea and water. In some embodiments, the ammonium carbamate decomposition reaction has a conversion of about 50% to about 60% urea, and the unreacted feed is recycled. The conversion of the reaction can be determined by the reactor design and the operating temperature. In some embodiments, urea is separated from the reacted feed and the remaining feed is recycled.

In some embodiments, wherein the sorbent is immobilized in the unit 60, the reaction chamber 61 is thermally linked to one or more additional reactor units such that the energy is transferred sequentially to other reactors entering the regeneration phase.

FIG. 2B depicts another example system for the integration of the CO₂ capture process and the urea production process. The system shown in FIG. 2B is a variant of the system depicted in FIG. 2A where the sorbent is in one or more enclosures (a regeneration chamber 81) within a urea reaction vessel 80 such that the reaction of CO₂ and ammonia occurs around the sorbent material enclosure and the heat generated from the reaction is transferred to the sorbent. In some embodiments, the one or more enclosures are formed of high thermal conductivity material.

FIG. 2B depicts an example system 3000 in which a CO₂ stream 802 and an ammonia stream 803 are provided to the reaction vessel 80. In some embodiments, a stream 803 has an ammonia to CO₂ molar flow ratio between 2 and 6, between 2 and 4, or between 2.5 and 3. In some embodiments, the reaction of CO₂ and ammonia in vessel 80 is carried out at a temperature between 130° C. and 230° C., or between 170° C. and 200° C., and a pressure between 110 bar and 300 bar, or between 110 bar and 150 bar. Within the reaction vessel 80, CO₂ and ammonia react exothermically, releasing heat and forming ammonium carbamate, which decomposes to form urea and water. The reaction mixture exits the reactor as an effluent stream 804 that includes unreacted ammonia, unreacted ammonium carbamate, urea, and water, and may also include unreacted CO₂. Similar to the effluent stream 506 shown in FIG. 2A, the effluent stream 804 can undergo further processing in separation and purification system 83 to separate unreacted ammonia (a stream 809) and ammonium carbamate (a stream 810) from urea and water (a stream 811).

Concurrent with the urea reaction process, a CO₂ rich sorbent 800 (e.g., a sorbent saturated with CO₂) is provided to a sorbent regeneration chamber 81, which is embedded within the reaction vessel 80. In some embodiments, sorbent 800 is provided at the adsorption temperature. In some embodiments, sorbent 800 is preheated to a temperature between the adsorption temperature and the regeneration temperature. In some embodiments, the sorbent regeneration chamber 81 comprises one or more tubes distributed within the reaction vessel 80 to allow for heat transfer between the reaction vessel 80 and the sorbent regeneration chamber 81. In some embodiments, the sorbent 800 is regenerated by the heat released from the CO₂ and ammonia reaction and exits as the sorbent 801 having a lower CO₂ saturation level than sorbent 800 (i.e., a lean CO₂ sorbent). In some embodiments, regeneration chamber 81 includes additional heater elements or heat exchangers that can supply the sorbent with additional heat to help regenerate the sorbent. In some embodiments, the regeneration chamber 81 is under vacuum to assist with sorbent regeneration.

The desorbed CO₂ exits the sorbent regeneration chamber 81 via a stream 805. In some embodiments, the stream 805 includes water vapor along with CO₂. The stream 805 can be optionally compressed in a compression train 82 to the urea reactor pressure, and water can be knocked out following the compression stages and evacuated via a stream 807. The compressed and relatively dry stream 806 exiting the compression unit 82 is sent to the reactor chamber via a stream 802. In some embodiments, an additional CO₂ stream 808 is mixed with stream 806 into the stream 802. In some embodiments, additional CO₂ is not added to the stream 806 and the stream 802 is essentially stream 806 (e.g., the stream 808 is not present).

FIG. 2C depicts another example system 4000 for the integration of the CO₂ capture process and the urea production process. The system 4000 includes a reactor unit 1000 which contains a sorbent. In some embodiments, the sorbent is fixed to the reactor unit and is immobilized. In some embodiments, the sorbent is flown through reactor 1000, such that a CO₂ rich sorbent 2003 enters the reactor 1000, is heated and is regenerated, and exits as CO₂ deficient sorbent 2004. In some embodiments, the sorbent is preheated to about 20-30%, 30-40%, 40-50%, 50-60%, 60-70%, 80-90% or about 100% of the regeneration temperature. The adsorbates desorb from the sorbent to regenerate the sorbent. The desorbed species exit the reactor unit 1000 via a stream 2006. In some embodiments, the stream 2006 includes mainly CO₂. In some embodiments, the stream 2006 includes both CO₂ and H₂O. In some embodiments, the stream 2006 enters a multi-stage compression and cooling unit 1001, in which CO₂ is compressed to the urea reaction pressure, and exits as a stream 2008. In some embodiments, the urea reaction pressure is between 110 bar and 300 bar, or between 110 bar and 150 bar. Water and other condensable species in the stream 2006, if any, are knocked out by the unit 1001 and exit via a stream 2007. The unit 1001 can remove, for example, about 50-70%, 70-90%, or between 90-99% of the condensable species.

In some embodiments, the CO₂ stream 2008 is mixed with an external CO₂ stream 2009 to form a stream 2002 to adjust the mass and energy balances of the integrated processes such that enough CO₂ and ammonia react to supply sufficient energy to regenerate the sorbent. In some embodiments, additional CO₂ is not added to stream 2008 and stream 2002 is essentially stream 2008 (e.g., the stream 2009 is not present). The 2002 is mixed with an ammonia stream 2001 to provide a stream 2010 such that the ammonia to CO₂ molar flow ratio is between 2 to 4, 2 to 3, or 2.5 to 3. The stream 2010 enters the reaction chamber 1010 where CO₂ and ammonia react exothermically to form ammonium carbamate, which then decomposes into urea and water. In some embodiments, urea is formed in the reactor 1010. In some embodiments, CO₂ and ammonia first react to form ammonium carbamate in the reactor 1010 which is then decomposed into urea in another reactor downstream of the reactor 1010.

The reactor 1010 is embedded or thermally linked to unit 1000 where the sorbent is regenerated, such that the heat released by the CO₂ and ammonia reaction is transferred to the sorbent to desorb the adsorbates. In some embodiments, the heat transfer controls the temperature of the reactor 1010. In some embodiments, the reactor 1010 includes multiple tubes in direct contact with the solid sorbent, and the sorbent contacts the tubes of chamber. In some embodiments, external heaters are used to supplement the energy provided by the CO₂ and ammonia reaction. For example, when the energy provided by the ammonium carbamate reaction is less than the energy to desorb the sorbed CO₂. In some embodiments, wherein the sorbent is immobilized in the unit 1000, the reaction chamber 1010 is thermally linked to a one or more additional reactor units such that the energy is transferred sequentially to other reactors entering the regeneration phase.

The reactor effluent stream 2005 contains species formed due to the interaction of the stream 2010 and the reaction chamber 1010. In some embodiments, the reactor effluent stream 2005 includes unreacted ammonia, ammonium carbamate, urea, and water. In some embodiments, CO₂ is completely consumed by the reaction in the chamber 1010. In some embodiments, CO₂ is not completely consumed and the remaining CO₂ exits via the stream 2005. Similar to the effluent stream 506 shown in FIG. 2A, the reactor effluent stream 2005 can undergo further processing in a separation and purification system 1050 to separate unreacted ammonia and CO₂ (a stream 2051), and ammonium carbamate (a stream 2052) from urea and water (a stream 2053).

While certain embodiments involving the desorption of CO₂ from a sorbent a are described above, the disclosure is not limited in this sense. Rather, the systems and methods disclosed herein can apply to a variety of sorbed species other than CO₂ and chemical reactions that generate heat other than the reaction of CO₂ and ammonia. In general, a method of treating a sorbent having a species sorbed thereto includes reacting a first reactant and a second reactant to generate heat, and heating the sorbent with the generated heat to desorb the sorbed species from the sorbent.

The first reactant includes a molecule having the same chemical identity as the sorbed species (i.e., the first reactant comprises a species having the same chemical formula as the sorbed species). For example, the sorbed species is CO₂ and the first reactant includes CO₂. The first reactant and the sorbed species can include any suitable molecule that can be sorbed (e.g., adsorbed or absorbed) by the sorbent. In some embodiments, the sorbed species is an adsorbate. In some embodiments, the sorbed species is an absorbate. Examples of the sorbed species include CO₂, H₂S, SOₓ (e.g. SO₂, SO₃), NOₓ (e.g. NO, NO₂, N₂O), CO, H₂O, O₂, N₂, NH₃, H₂, CH₄, and C₂H₂.

In some embodiments, the sorbed species is CO₂ that is sorbed (i.e., captured) from any CO₂-containing stream. For example, the CO₂-containing stream is flue gas or ambient air.

In some embodiments, the first reactant is a gas. For example, the first reactant is CO₂. In some embodiments, the first reactant is CO₂ included within a gas stream.

In some embodiments, the first reactant is a species desorbed from the sorbent. For example, the first reactant is CO₂ that was desorbed from the sorbent.

The second reactant can be any suitable chemical species that is capable of exothermically reacting with the first reactant to generate heat. In some embodiments, the second reactant is a gas. Examples of the second reactant include ammonia, an epoxide, a phenolate, and hydrogen. In some embodiments, the second reactant includes ammonia.

In some embodiments, the first reactant is CO₂, the second reactant is ammonia, and the product is ammonium carbamate.

In some embodiments, while the first reactant is CO₂, the second reactant is an epoxide rather than ammonia, and the product is a cyclic carbonate.

In some embodiments, while the first reactant is CO₂, the second reactant is a phenolate rather than ammonia, and the product is salicylic acid.

In some embodiments, while the first reactant is CO₂, the second reactant is hydrogen rather than ammonia, and the products are synthetic gases, methanol or methane.

In some embodiments, the reaction forms a final reaction product. For example, CO₂ is hydrogenated to form methanol. In some embodiments, the reacting forms an intermediate product. For example, CO₂ is reacted with ammonia to form ammonium carbamate (reaction (1)), which is an intermediate product that can be subsequently reacted to form urea (reaction (2)).

The methods disclosed herein can apply to a variety of sorbents. In some embodiments, the sorbent is a liquid sorbent. Examples of liquid sorbents include an amine solvent, an ionic liquid, a hydroxide-containing liquid, and a caustic solution. As used herein, “caustic solution” refers to a solution that includes caustic soda (i.e., sodium hydroxide). Examples of amine solvents include monoethanolamine (MEA), methyldiethanolamine (MDEA), and diglycolamine (DGA).

In some embodiments, the sorbent is a solid sorbent. Examples of solid sorbents include a metal organic framework (MOF), a covalent organic framework (COF), a zeolitic imidazolate framework (ZIF), a zeolite, a hyper cross-linked organic polymer (HCP), a Scholl-coupled organic polymer (SCP), a conjugated microporous organic polymer (CMP), an amine fixed on a solid support, and an amino polymer.

As used in this disclosure, the term “about” can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited.

Particular embodiments of the subject matter have been described. Other implementations, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

### EXAMPLES

Aspen Adsorption was used to simulate a CO₂ adsorption capture process. Simulations were conducted for CO₂ capture from a natural gas combine cycle (NGCC) flue stream. NbOFFive-1-Ni was chosen as the sorbent material. The Peng Robinson equation of state was used to define the thermodynamic properties of the components. The adsorption bed was defined as a 1.77 m³ vertical cylindrical vessel. The discretization method was chosen as the upwind differencing scheme 1 (UDS1) with 20 spatial nodes. The Langmuir II isotherm equation and the ideal adsorption solution theorem were chosen to define component loading and account for component adsorption competitiveness respectively. The adsorption kinetics were defined with lumped resistance and the component mass transfer coefficients were defined by the Arrhenius equation to account for temperature dependence. The momentum balance was defined by the Ergun equation and used to estimate the pressure drop across the bed. The energy balance was defined as non-isothermal with gas and solid conduction and does not consider heat transfer with surrounds to account for the energy needed to heat and recover the material. The capture cycle consists of an adsorption, vacuum purge, desorption, recovery and cooling step.

The model provided a cyclic thermal energy demand of around 209.1 MJ/kmol of CO₂ desorbed and recovered in the product stream. This energy considers the energy to heat up the sorbent material to the regeneration temperature and the energy consumed by the heat of desorption of CO₂ and water.

Provided that the reaction to form ammonium carbamate goes to near completion, the energy release is around 117 to 160 MJ/kmol of ammonium carbamate, the urea reaction involves from 15 to 33 MJ/kmol of urea, and recycling back any unconverted compounds, the overall energy released would be around 102 to 127 MJ per kmol of ammonium carbamate formed or per kmol of CO₂ reacted since their stoichiometric coefficients are equal.

To have the energy released by the urea reaction be equivalent to the sorbent regeneration energy, one would need to react around 1.65 to 2.05 kmol of CO₂ for the urea production reaction. Thus, to have the sorbent regeneration energy equivalent to the energy released by the urea reaction, one would need to supply around 0.65 to 1.05 kmol of CO₂ in addition to the CO₂ desorbed by the sorbent. This CO₂ could be obtained from adjacent CO₂ capture systems that use conventional methods to regenerate the sorbent. Depending on the sorbent properties such as specific heat capacity, CO₂ heat of adsorption/desorption, and affinity to H₂O adsorption, the energy to regenerate CO₂ could be such that little to no additional CO₂ would be involved. Additionally, schemes encompassing energy recovery systems that can preheat the CO₂-rich sorbent by transferring the energy from the freshly regenerated sorbent would reduce the total energy demand and reduce the dependence on external sources to regenerate the sorbent.

### EXEMPLARY EMBODIMENTS

1) A method of treating a sorbent having a species sorbed thereto, the method comprising:
reacting a first reactant and a second reactant to generate heat, wherein the first reactant comprises a molecule having the same chemical identity as the sorbed species; and
heating the sorbent with the generated heat to desorb the sorbed species from the sorbent.
   2) The method of Embodiment 1, wherein the first and second reactants comprise gases.
   3) The method of Embodiment 1 or 2, wherein the sorbed species and the first reactant comprise CO₂.
   4) The method of Embodiment 3, wherein the method further comprises using the desorbed CO₂ as a feedstock for urea production.
   5) The method of any one of Embodiments 1 to 4, wherein the second reactant comprises at least one member selected from the group consisting of ammonia, an epoxide, a phenolate, and hydrogen.
   6) The method of any one of Embodiments 1 to 5, wherein the second reactant comprises ammonia.
   7) The method of any one of Embodiments 1 to 6, wherein the sorbed species and the first reactant comprise CO₂, the second reactant comprises ammonia, and the reacting forms ammonium carbamate.
   8) The method of any one of Embodiments 1 to 7, wherein one of the following holds:
the sorbent comprises at least one member selected from the group consisting of an amine solvent, an ionic liquid, a hydroxide-containing liquid, and a caustic solution; and
the sorbent comprises at least one member selected from the group consisting of a metal organic framework (MOF), a covalent organic framework (COF), a zeolitic imidazolate framework (ZIF), a zeolite, a hyper cross-linked organic polymer (HCP), a Scholl-coupled organic polymer (SCP), a conjugated microporous organic polymer (CMP), an amine fixed on a solid support, and an amino polymer.
   9) The method of any one of Embodiments 1 to 8, further comprising reducing a pressure adjacent the sorbent to desorb at least some of the sorbed species.
   10) The method of any one of Embodiments 1 to 9, wherein an energy to desorb the sorbed species from the sorbent is equal to or lesser than an energy provided by the generated heat.
   11) The method of any one of Embodiments 1 to 9, wherein an energy to desorb the sorbed species from the sorbent is greater than an energy provided by the generated heat, and the method further comprises providing additional heat to the sorbent.
   12) The method of any one of Embodiments 1 to 11, wherein a molar flow ratio of the second reactant to the first reactant is between 2 and 6.
   13) The method of any one of Embodiments 1 to 12, wherein the reacting is carried out at a temperature between about 130° C. and about 230° C.
   14) The method of any one of Embodiments 1 to 13, wherein the exothermic reaction is carried out at a pressure between about 30 bar and about 300 bar.
   15) The method of any one of Embodiments 1 to 14, wherein the sorbent is heated to a regeneration temperature of about 80° C. to about 200° C.
   16) The method of any one of Embodiments 1 to 15, further comprising preheating the sorbent to a temperature of about 50° C. to about 200° C.
   17) The method of any one of Embodiments 1 to 16, further comprising transferring the heat to the sorbent using at least one member selected from the group consisting of a heat exchanger and a heating medium.
   18) The method of any one of Embodiments 1 to 17, wherein the first reactant is a species desorbed from the sorbent.
   19) A system configured to desorb a species from a sorbent, the system comprising:
a reactor unit comprising the sorbent;
a first inlet;
a second inlet;
a first outlet; and
a circulation cycle,
wherein the system is configured so that, during use of the system:
   the species is desorbed from the sorbent to provide a first gaseous reactant;
   a second gaseous reactant enters the system via the first inlet;
   a gas comprising the first and second gaseous reactants exits the reactor unit via the first outlet and passes through the circulation cycle where the gas is purified and compressed gas;
   the purified and compressed gas enters the system via the second inlet; and
   the first and second gaseous reactants in the purified and compressed stream react to provide heat that assists in the desorption of the species from the sorbent.
      20) A system configured to desorb a species from a sorbent, the system comprising:
a reactor unit comprising the sorbent;
a first inlet;
a second inlet;
a first outlet;
a second outlet; and
a circulation cycle,
wherein the system is configured so that, during use of the system:
   the species is desorbed from the sorbent to provide a first gaseous reactant;
   a first gas comprising the first gaseous reactant exits the reactor unit via the first outlet, and passes through the circulation cycle to purify the first gas;
   the purified first gas enters the reactor unit via the first inlet;
   a second gaseous reactant enters the system via the second inlet;
   the first and second gaseous reactants react within the reactor unit to provide heat that assists in the desorption of the adsorbed species from the sorbent and to provide a reaction product; and
   the first gas and the reaction product exit the reactor unit via the second outlet.

What is claimed is:

1. A method of treating a sorbent having a species sorbed thereto, the method comprising:
reacting a first reactant and a second reactant to generate heat, wherein the first reactant comprises a molecule having the same chemical identity as the sorbed species; and
heating the sorbent with the generated heat to desorb the sorbed species from the sorbent.

2. The method of claim 1, wherein the first and second reactants comprise gases.

3. The method of claim 1, wherein the sorbed species and the first reactant comprise CO₂.

4. The method of claim 3, wherein the method further comprises using the desorbed CO₂ as a feedstock for urea production.

5. The method of claim 1, wherein the second reactant comprises at least one member selected from the group consisting of ammonia, an epoxide, a phenolate, and hydrogen.

6. The method of claim 1, wherein the second reactant comprises ammonia.

7. The method of claim 1, wherein the sorbed species and the first reactant comprise CO₂, the second reactant comprises ammonia, and the reacting forms ammonium carbamate.

8. The method of claim 1, wherein one of the following holds:
the sorbent comprises at least one member selected from the group consisting of an amine solvent, an ionic liquid, a hydroxide-containing liquid, and a caustic solution; and
the sorbent comprises at least one member selected from the group consisting of a metal organic framework (MOF), a covalent organic framework (COF), a zeolitic imidazolate framework (ZIF), a zeolite, a hyper cross-linked organic polymer (HCP), a Scholl-coupled organic polymer (SCP), a conjugated microporous organic polymer (CMP), an amine fixed on a solid support, and an amino polymer.

9. The method of claim 1, further comprising reducing a pressure adjacent the sorbent to desorb at least some of the sorbed species.

10. The method of claim 1, wherein an energy to desorb the sorbed species from the sorbent is equal to or lesser than an energy provided by the generated heat.

11. The method of claim 1, wherein an energy to desorb the sorbed species from the sorbent is greater than an energy provided by the generated heat, and the method further comprises providing additional heat to the sorbent.

12. The method of claim 1, wherein a molar flow ratio of the second reactant to the first reactant is between 2 and 6.

13. The method of claim 1, wherein the reacting is carried out at a temperature between about 130° C. and about 230° C.

14. The method of claim 1, wherein the exothermic reaction is carried out at a pressure between about 30 bar and about 300 bar.

15. The method of claim 1, wherein the sorbent is heated to a regeneration temperature of about 80° C. to about 200° C.

16. The method of claim 1, further comprising preheating the sorbent to a temperature of about 50° C. to about 200° C.

17. The method of claim 1, further comprising transferring the heat to the sorbent using at least one member selected from the group consisting of a heat exchanger and a heating medium.

18. The method of claim 1, wherein the first reactant is a species desorbed from the sorbent.

19. A system configured to desorb a species from a sorbent, the system comprising:
a reactor unit comprising the sorbent;
a first inlet;
a second inlet;
a first outlet; and
a circulation cycle,
wherein the system is configured so that, during use of the system:
the species is desorbed from the sorbent to provide a first gaseous reactant;
a second gaseous reactant enters the system via the first inlet;
a gas comprising the first and second gaseous reactants exits the reactor unit via the first outlet and passes through the circulation cycle where the gas is purified and compressed gas;
the purified and compressed gas enters the system via the second inlet; and
the first and second gaseous reactants in the purified and compressed stream react to provide heat that assists in the desorption of the species from the sorbent.

20. A system configured to desorb a species from a sorbent, the system comprising:
a reactor unit comprising the sorbent;
a first inlet;
a second inlet;
a first outlet;
a second outlet; and
a circulation cycle,
wherein the system is configured so that, during use of the system:
the species is desorbed from the sorbent to provide a first gaseous reactant;
a first gas comprising the first gaseous reactant exits the reactor unit via the first outlet, and passes through the circulation cycle to purify the first gas;
the purified first gas enters the reactor unit via the first inlet;
a second gaseous reactant enters the system via the second inlet;
the first and second gaseous reactants react within the reactor unit to provide heat that assists in the desorption of the adsorbed species from the sorbent and to provide a reaction product; and
the first gas and the reaction product exit the reactor unit via the second outlet.
